(19) United States
(12) Patent Application Publication
(10) Pub. No.: US 2026/0307874 A1
(43) Pub. Date: Oct. 8, 2026

(54) LOW COF PACKAGING FILM AND PACKAGE INCLUDING THE SAME

(71) Applicant: AMCOR FLEXIBLES NORTH AMERICA, INC., NEENAH, WI (US)

(72) Inventor: JACOB A. LASEE, New London, WI (US)

(21) Appl. No.: 19/482,180

(22) PCT Filed: Jun. 6, 2023
(86) PCT No.: PCT/US2023/024531

§ 371 Date: Nov. 6, 2025

(51) Int. Cl. B65D 75/26; B32B 7/022; B32B 27/18; B32B 27/32; B32B 27/36; B65D 75/20

(52) U.S. Cl. CPC B65D 75/26; B32B 7/022; B32B 27/18; B32B 27/32; B32B 27/36; B65D 75/20; B32B 2307/412; B32B 2307/7376; B32B 2307/746; B32B 2439/00

(57) ABSTRACT

A low coefficient of friction (COF) packaging film is disclosed. The low COF packaging film includes a first layer forming a first exterior surface of the low COF packaging film. The first layer includes a first polymer. The low COF packaging film further includes a second layer forming a second exterior surface of the low COF packaging film. The second layer includes a heat sealable polymer blend. The first layer is connected to the second layer. The first exterior surface includes a surface area roughness (Sa) in a range of from 25 nanometers (nm) to 250 nm. The first exterior surface has a static COF to itself less than 0.40 and a kinetic COF to itself less than 0.40, according to ASTM D1894.

### TECHNICAL FIELD

The present application relates generally to a low coefficient of friction (COF) packaging film and a package including the low COF packaging film.

### BACKGROUND

A packaging film may be formed into a package using packaging equipment. It may be desirable for the packaging film to have a low coefficient of friction (COF).

For example, a packaging film having a low COF may enhance packaging machine operations and/or improve a line speed of a package-forming process. In contrast, a packaging film having a high COF may not run properly on the packaging machines and may cause issues in the package-forming process.

Conventionally, to provide a low COF to a packaging film, a slip coating is applied to an exterior surface of the packaging film. The use of exterior applied slip coatings presents challenges including, but not limited to, consistent application, material management and material costs.

Alternatively, a low COF surface may be formed using antiblock particles to create a rough surface. Antiblock particles are commonly used to roughen packaging film surfaces, the particles sticking out from the film surface. However, roughening in this manner may lose effectiveness if they get smashed below the film surface by the action of the drum and nip roll. Antiblock particles can cause light scatter throughout the bulk of the layer in which they are incorporated causing unwanted optical issues (high haze and low clarity).

### SUMMARY

A low coefficient of friction (COF) packaging film has been developed. The low COF packaging film includes a first exterior surface having a static COF to itself less than 0.40 and a kinetic COF to itself less than 0.40, according to ASTM D1894.

The first exterior surface of the low COF packaging film may have a low COF (specifically, both a low static COF and a low kinetic COF) to itself without use of a slip coating. The low COF packaging film may be free of the slip coating. As a result, the low COF packaging film may be free from drawbacks that are typically associated with the use of slip coatings. Moreover, the low COF packaging film may have optical properties that are suitable for packaging applications (such as clarity and haze).

One embodiment of the present disclosure is a low coefficient of friction (COF) packaging film. The low COF packaging film includes a first layer. The first layer forms a first exterior surface of the low COF packaging film. The first layer includes a first polymer. The low COF packaging film further includes a second layer. The second layer forms a second exterior surface of the low COF packaging film. The second layer includes a heat sealable polymer blend. The first layer is connected to the second layer. The first exterior surface includes a surface area roughness (Sa) in a range of from 25 nanometers (nm) to 250 nm, as measured according to ISO 25178. The first exterior surface has a static COF to itself less than 0.40 and a kinetic COF to itself less than 0.40, according to ASTM D1894.

The first exterior surface of the low COF packaging film may have a low COF (both a low static COF and a low kinetic COF) to itself. The low COF packaging film may therefore run properly on packaging machines/equipment.

The surface area roughness (Sa) of the first exterior surface in the range of from 25 nm to 250 nm may play a role in providing the first exterior surface with the low COF to itself. Furthermore, the surface area roughness (Sa) of the first exterior surface in the range of from 25 nm to 250 nm may not detrimentally affect optical properties of the low COF packaging film that are desirable in packaging applications (such as clarity and haze). The low COF packaging film may therefore be suitable for various packaging applications.

Advantageously, the first exterior surface of the low COF packaging film may have the low COF to itself without use of a slip coating. As a result, the low COF packaging film may be free from drawbacks that are typically associated with the use of slip coatings (such as quality issues due to skips or inconsistencies in the coating). Being free of the slip coating may also improve a recyclability of the low COF packaging film.

Moreover, the low COF packaging film may be easily formed into a package. The second layer of the low COF packaging film may be sealed to itself or to a layer of another packaging film to form the package.

In some embodiments, the first layer further includes a slip agent blended with the first polymer. The slip agent may be comprised in a range of from 0.25% to 1.15% of a slip agent, by weight. The slip agent may further play a role in providing the first exterior surface with the low COF properties.

In some embodiments, the slip agent includes at least one of a primary amide slip agent, a secondary amide slip agent and a bis-amide slip agent.

In some embodiments, the first layer includes a thickness in a range of from 12 microns to 254 microns.

In some embodiments, the first polymer is one of a polymer selected from the list of a polyamide polymer, a styrene polymer, a polyester polymer, and a polypropylene polymer.

In some embodiments, the first polymer is a polycaprolactam polymer.

In some embodiments, the heat sealable polymer blend includes a polyolefin polymer.

In some embodiments, the low COF packaging film includes a haze in a range of from 1% to 50%, according to ASTM D1003, Procedure A. In some embodiments, the low COF packaging film includes a clarity greater than 75%, according to ASTM D1003, Procedure A. The aforementioned haze and clarity of the low COF packaging film may make the low COF packaging suitable for various packaging applications.

Another embodiment of the present disclosure is a low coefficient of friction (COF) packaging film. The low COF packaging film includes a first layer. The first layer forms a first exterior surface of the low COF packaging film. The first layer includes a polyamide polymer and in a range of from 0.25 weight % to 1.15 weight % of a slip agent. The first exterior surface includes a surface area roughness (Sa) in a range of from 25 nanometers (nm) to 250 nm, as measured according to ISO 25178. The low COF packaging film includes a haze in a range of from 1% to 50% and a clarity greater than 75%, according to ASTM D1003, Procedure A.

The surface area roughness (Sa) of the first exterior surface in the range of from 25 nm to 250 nm may not detrimentally affect optical properties of the low COF packaging film that are desirable in packaging applications (such as clarity and haze). As a result, the low COF packaging film includes the haze in the range of from 1% to 50% and the clarity greater than 75%, according to ASTM D1003, Procedure A. The low COF packaging film may therefore be suitable for various packaging applications.

In some embodiments, the first exterior surface has a static COF to itself less than 0.40 and a kinetic COF to itself less than 0.40, according to ASTM D1894.

The surface area roughness (Sa) of the first exterior surface and the slip agent of the first layer may provide the first exterior surface with a low COF (both a low static COF and a low kinetic COF) to itself. Advantageously, the first exterior surface of the low COF packaging film may have the low COF to itself without use of a slip coating. As a result, the low COF packaging film may be free from drawbacks that are typically associated with the use of slip coatings (such as quality issues due to skips or inconsistencies in the coating). Being free of the slip coating may also improve a recyclability of the low COF packaging film.

In some embodiments, the first layer includes a thickness in a range of from 12 microns to 254 microns.

In some embodiments, the first polymer is a polycaprolactam polymer.

In some embodiments, the slip agent includes at least one of a primary amide slip agent, a secondary amide slip agent and a bis-amide slip agent.

Another embodiment of the present disclosure is a package. The package includes a low COF packaging film. The low COF packaging film includes a first layer. The first layer forms a first exterior surface of the low COF packaging film. The first layer includes a first polymer. The low COF packaging film further includes a second layer. The second layer forms a second exterior surface of the low COF packaging film. The second layer includes a heat sealable polymer blend. The first layer is connected to the second layer. The first exterior surface includes a surface area roughness (Sa) in a range of from 25 nanometers (nm) to 250 nm, as measured according to ISO 25178. The first exterior surface has a static COF to itself less than 0.40 and a kinetic COF to itself less than 0.40, according to ASTM D1894.

The package may be formed by sealing the second layer of the low COF packaging film to itself. Alternatively, the package may be formed by sealing the second layer of the low COF packaging film to a layer of another packaging film.

The low COF packaging film may have optical properties (such as clarity and haze) that are suitable for various packaging applications. Thus, the package including the low COF packaging film may have good optical properties.

In some embodiments, the low COF packaging film has been thermoformed into a non-planar shape. This may allow the package to have various non-planar shapes based on application requirements.

In some embodiments, the low COF packaging film is folded onto itself. Further, the second layer is sealed to itself.

Another embodiment of the present disclosure is a package. The package includes a first low COF packaging film and a second low COF packaging film. Each of first and second low COF packaging films includes a first layer forming a first exterior surface of the corresponding first or second low COF packaging film. The first layer includes a first polymer. Each of first and second low COF packaging films further includes a second layer forming a second exterior surface of the corresponding first or second low COF packaging film. The second layer includes a heat sealable polymer blend. The first layer is connected to the second layer. The first exterior surface includes a surface area roughness (Sa) in a range of from 25 nanometers (nm) to 250 nm, as measured according to ISO 25178. The first exterior surface has a static COF to itself less than 0.40 and a kinetic COF to itself less than 0.40, according to ASTM D1894. The second layer of the first low COF packaging film is sealed to the second layer of the second low COF packaging film.

The package may be formed from the first low COF packaging film and the second low COF packaging film by sealing the second layer of the first low COF packaging film to the second layer of the second low COF packaging film.

Each of the first and second low COF packaging films may have optical properties (such as clarity and haze) that are suitable for various packaging applications. Thus, the package including the first and second low COF packaging films may have good optical properties.

There are several aspects of the present subject matter which may be embodied separately or together. These aspects may be employed alone or in combination with other aspects of the subject matter described herein, and the description of these aspects together is not intended to preclude the use of these aspects separately or the claiming of such aspects separately or in different combinations.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic cross-sectional view of a low COF packaging film in accordance with an embodiment of the present disclosure;

FIG. 2 is a schematic cross-sectional view of a low COF packaging film in accordance with another embodiment of the present disclosure;

FIG. 3A is a schematic perspective view of a package in accordance with an embodiment of the present disclosure;

FIG. 3B is a schematic cross-sectional view of the package taken along a line 1-1 of FIG. 3A in accordance with an embodiment of the present disclosure; and

FIG. 4 is a schematic cross-sectional view of a package in accordance with another embodiment of the present disclosure.

The figures are not necessarily to scale. Like numbers used in the figures refer to like components. It will be understood, however, that the use of a number to refer to a component in a given figure is not intended to limit the component in another figure labelled with the same number.

### DETAILED DESCRIPTION

A low coefficient of friction (COF) packaging film has been developed. The low COF packaging film includes a first layer. The first layer forms a first exterior surface of the low COF packaging film. The first layer includes a first polymer. The low COF packaging film further includes a second layer. The second layer forms a second exterior surface of the low COF packaging film. The second layer includes a heat sealable polymer blend. The first layer is connected to the second layer. The first exterior surface includes a surface area roughness (Sa) in a range of from 25 nanometers (nm) to 250 nm, as measured according to ISO 25178. The first exterior surface has a static COF to itself less than 0.40 and a kinetic COF to itself less than 0.40, according to ASTM D1894.

The first exterior surface of the low COF packaging film may have a low COF (both a low static COF and a low kinetic COF) to itself. The low COF packaging film may therefore run properly on packaging machines/equipment.

The surface area roughness (Sa) of the first exterior surface in the range of from 25 nm to 250 nm may play a role in providing the first exterior surface with the low COF to itself. Furthermore, the surface area roughness (Sa) of the first exterior surface in the range of from 25 nm to 250 nm may not detrimentally affect optical properties of the low COF packaging film that are desirable in packaging applications (such as clarity and haze). The low COF packaging film may therefore be suitable for various packaging applications.

Advantageously, the first exterior surface of the low COF packaging film may have the low COF to itself without use of a slip coating. As a result, the low COF packaging film may be free from drawbacks that are typically associated with the use of slip coatings (such as quality issues due to skips or inconsistencies in the coating). Being free of the slip coating may also improve a recyclability aspect of the low COF packaging film.

Moreover, the low COF packaging film may be easily formed into a package. The second layer of the low COF packaging film may be sealed to itself or to a layer of another packaging film to form the package.

As used herein, “at least one of A and B” should be understood to mean “only A, only B, or both A and B”.

As used herein, the term “film” refers to a single-layered or multi-layered web that has a very high ratio of length or width to thickness. A film has two exterior surfaces defined by a length and a width.

As used herein, the term “layer” refers to a thickness of a material or blend of materials that may be continuous or discontinuous. Layers may be considered as building blocks of a film. In other words, a film may include one or more layers.

As used herein, the term “packaging film” refers to a film that is suitable for forming a package. The package formed from the packaging film may partially or completely encompass a product packaged therein. The term “package” refers to a structure formed from one or more packaging films that at least partially encompasses a product.

As used herein, the term “coefficient of friction” or “COF” refers to a ratio of the force required to slide one surface of film across another surface relative to the gravimetric force exerted on it. Low COF films may be considered “high slip” and may present less friction against movement against other objects. COF of films may be measured using ASTM D1894 “Standard Method of Test for Coefficient of Friction of Plastic Film.”

As used herein, the term “static coefficient of friction” or “static COF” refers to the stationary resistance of one surface relative to another surface. Static COF may also be referred to as “budging force.” Static COF is the ratio of the force required to start to move one surface over another to the total force applied normal to those surfaces. Static COF may be determined in accordance with ASTM D1894-14 (“Standard Test Method for Static and Kinetic Coefficients of Friction of Plastic Film and Sheeting”). A lower static COF value generally reflects a material that is easier to initially move.

As used herein, the term “kinetic coefficient of friction” or “kinetic COF” refers to the moving or sliding resistance of one surface across another surface. Kinetic COF may also be referred to as “friction force.” Kinetic COF is the ratio of the force required to move one surface over another to the total force applied normal to those surfaces, once that motion is in progress. Kinetic COF may be determined in accordance with ASTM D1894-14 (“Standard Test Method for Static and Kinetic Coefficients of Friction of Plastic Film and Sheeting”). A lower kinetic COF value generally reflects a material that is easier to move subsequent to its initial movement.

As used herein, the term “surface area roughness (Sa)” refers to the arithmetic average roughness of a surface as measured according to ISO 25178. As used herein, the term “surface roughness (Ra)” refers to the arithmetic average of the two-dimensional roughness profile (i.e., the Ra value) measured in a line across a surface. Measurement techniques of surface roughness (Ra) include, but are not limited to, using a contact-type roughness meter (i.e., a profilometer) that detects the surface by use of a physical probe, or by detecting the reflected light of a laser beam (i.e., a laser scanner).

Unless specified or limited otherwise, the terms “attached,” “connected,” “coupled,” and variations thereof are used broadly and encompass both direct and indirect attachments, connections, and couplings.

As used herein, the term “polymer” or “polymeric” refers to a material that is the product of a polymerization or copolymerization reaction of natural, synthetic, or natural and synthetic monomers and/or comonomers, and is inclusive of homopolymers, copolymers, terpolymers, etc.

As used herein, the term “polyolefin” refers broadly to polymers such as polyethylene, ethylene-alpha olefin copolymers (EAO), polypropylene, polybutene, ethylene copolymers having a majority amount by weight of ethylene polymerized with a lesser amount of a co-monomer, such as vinyl acetate, and other polymeric resins falling in the “olefin” family classification.

As used herein, the term “polyethylene” or “PE” refers to polymers that include an ethylene linkage. Polyethylenes may be homopolymers, copolymers, or interpolymers. Polyethylene copolymers or interpolymers may include other types of polymers (i.e., non-polyethylene polymers). Polyethylenes may have functional groups incorporated by grafting or other means. Polyethylenes include, but are not limited to, low-density polyethylene (LDPE), linear low density polyethylene (LLDPE), medium-density polyethylene (MDPE), ultra-low density polyethylene (ULDPE), high-density polyethylene (HDPE), cyclic-olefin copolymers (COC), ethylene vinyl acetate copolymers (EVA), ethylene acrylic acid copolymers (EAA), ethylene methacrylic acid copolymers (EMAA), neutralized ethylene copolymers such as ionomer, and maleic anhydride grafted polyethylene (MAHgPE).

As used herein, the term “polypropylene” or “PP” refers to polymers that are derived from monomers of propylene. Polypropylenes may be homopolymers, copolymers, or interpolymers. Polypropylene copolymers or interpolymers may include other types of polymers (i.e., non-polypropylene polymers). Propylene linkage can be represented by the general formula: [CH₂—CH(CH₃)]ₙ. Polypropylenes may have functional groups incorporated by grafting or other means. Polypropylenes include, but are not limited to, propylene-ethylene copolymers, ethylene-propylene copolymers, and maleic anhydride grafted polypropylenes (MAHgPP).

As used herein, the term “polyamide” refers to a high molecular weight polymer having amide linkages (—CONH—)ₙ which occur along the molecular chain, and includes “nylon” resins which are well known polymers having a multitude of uses including utility in packaging films. Examples of nylon polymeric resins suitable for use in packaging films include: nylon 66, nylon 610, nylon 66/610, nylon 6/66, nylon 11, nylon 6, nylon 66T, nylon 612, nylon 12, nylon 6/12, nylon 6/69, nylon 46, nylon 6-3-T, nylon MXD-6, nylon MXDI, nylon 12T and nylon 61/6T. Examples of polyamides include nylon homopolymers and copolymers such as nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6, 12 (poly(hexamethylene dodecanediamide)), nylon 6/12 (poly(caprolactam-co-dodecanediamide)), nylon 6,6/6 (poly(hexamethylene adipamide-co-caprolactam)), nylon 66/610 (e.g., manufactured by the condensation of mixtures of nylon 66 salts and nylon 610 salts), nylon 6/69 resins (e.g., manufactured by the condensation of epsilon-caprolactam, hexamethylenediamine and azelaic acid), nylon 11 (polyundecanolactam), nylon 12 (polylauryllactam) and copolymers or mixtures thereof.

As used herein, the term “styrene polymer” or “polystyrene” refers to a homopolymer or copolymer having at least one styrene monomer linkage (such as benzene (i.e., C₆H₅) having an ethylene substituent) within the repeating backbone of the polymer. The styrene linkage can be represented by the general formula: [CH₂—CH₂ (C₆H₅)]ₙ. Examples of polystyrene include, but are not limited to, graphite polystyrene general purpose polystyrene (GPS), and rubber-modified polystyrene, such as high impact polystyrene (HIPS).

As used herein, the term “polyester” or “PET” refers to a homopolymer or copolymer having an ester linkage between monomer units. The ester linkage may be represented by the general formula [O—R—OC(O)—R′—C(O)]ₙ where R and R′ are the same or different alkyl (or aryl) group and may generally be formed from the polymerization of dicarboxylic acid and diol monomers. Examples of polyester include, but are not limited to, amorphous polyethylene terephthalate (APET), polyethylene terephthalate glycol (PETG), and polylactic acid (PLA).

As used herein, the term “sealing layer” refers to a layer involved in the sealing of a film to itself or to other films. A sealing layer may be a heat-sealing layer that is heat sealable. That is, a sealing layer may be capable of fusion bonding by conventional indirect heating means which generate sufficient heat on at least one film contact surface for conduction to the contiguous film contact surface and formation of a bond interface therebetween without loss of the layer integrity. A sealing layer may include any suitable sealing composition, such as a heat sealable polymeric composition.

As used herein, the term “slip agent” refers to any additive incorporated into (i.e., blended with a polymer) one or more film layers which can modify the surface properties of a polymer film and, preferably, reduce the film-to-film friction, e.g., on a roll, and the friction between the film and other surfaces with which they come into contact with, e.g., production equipment. Slip agents may therefore enhance packaging machine operations due to reduced coefficient of friction values and/or improve line speed in the manufacturing process. Exemplary slip agents suitable for use according to the present application may include, but are not limited to, primary, secondary and bis-amide amide slip agents, such as stearyl erucamide, oleyl palmitamide, stearamides, oleamides, and erucamides. Examples of slip agents that may be useful include Tween® 20 or Tween® 80, Acrawax® C (N,N′ ethylene bis-stearamide wax), ethylene bis-oleamide, siloxanes, paraffin wax, microcrystalline wax, montan wax, carnauba wax, polystyrene wax, polyethylene wax, polypropylene wax, beeswax, and anhydrous lanolin.

As used herein, the term “slip coating” refers to a coating that is applied to a surface of a film to improve the slip properties of the coated surface.

As used herein, the term “clarity” refers to the see-through quality of a material. Clarity may be defined as the specific light transmitting and narrow-angle-light scattering properties of a material and is determined in an angle range less than 2.5 degrees. Clarity may be determined in accordance with ASTM D1003-13 (“Standard Test Method for Haze and Luminous Transmittance of Transparent Plastics”). Clarity values are reported in percent. A high clarity value generally reflects a material that is more transparent and less cloudy.

As used herein, the term “haze” refers to the scattering of light as it passes through a material. Haze may be defined as the specific light-transmitting and wide-angle-light scattering properties of planar sections of a material. Haze may be determined in accordance with ASTM D1003-13 (“Standard Test Method for Haze and Luminous Transmittance of Transparent Plastics”). Haze values are reported in percent. A high haze value generally reflects a material that is more cloudy and less transparent.

As used herein, the term “gloss” refers to the shiny appearance of a material. Gloss may be defined as a measure of the light reflected by the surface of a material and is measured at a specific angle of reflection (20, 45, 60, 75, or 85 degrees) against a specific backing. Gloss may be determined in accordance with ASTM D2457-13 (“Standard Test Method for Specular Gloss of Plastic Films and Solid Plastics”). Gloss values are reported in Gloss Units. A high gloss value generally reflects a material that is more shiny.

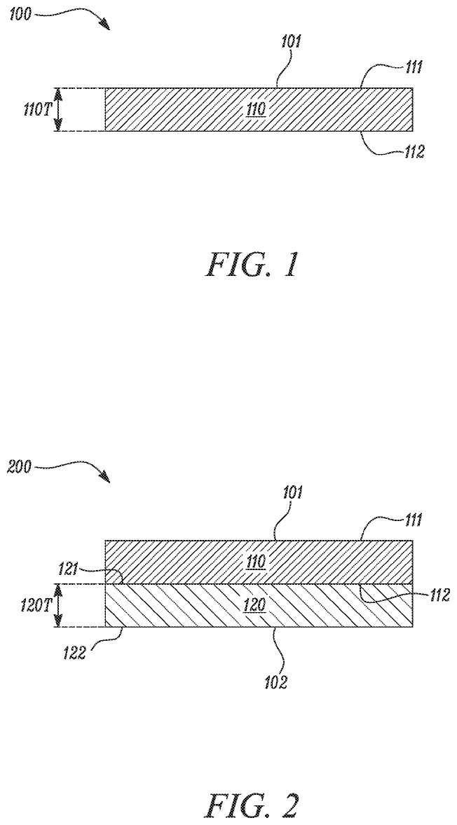

FIG. 1 shows a schematic cross-sectional view of a low COF packaging film 100 in accordance with an embodiment of the present disclosure.

Low COF packaging film 100 includes a first layer 110. First layer 110 may be a polymeric layer. Specifically, first layer 110 includes a first polymer. The first polymer may be one of a polymer selected from the list of a polyamide polymer, a styrene polymer, a polyester polymer, and a polypropylene polymer.

Specifically, in some embodiments, the first polymer may include a polyamide polymer. Examples of polyamide polymers include, but are not limited to, nylon-6 and nylon-6,6. In some embodiments, the first polymer may be a polycaprolactam polymer (i.e., nylon-6).

In some embodiments, the first polymer may include a styrene polymer. Examples of styrene polymers include, but are not limited to, graphite polystyrene (GPS) and rubber-modified polystyrene, such as high impact polystyrene (HIPS).

In some embodiments, the first polymer may include a polyester polymer. Examples of polyester polymers include, but are not limited to, amorphous polyethylene terephthalate (APET), polyethylene terephthalate glycol (PETG), and polylactic acid (PLA).

In some embodiments, the first polymer may include a polypropylene polymer. Examples of polypropylene polymers include, but are not limited to, propylene-ethylene copolymers, ethylene-propylene copolymers, and maleic anhydride grafted polypropylenes (MAHgPP).

First layer 110 may further include in a range of from 0.25 weight % to 1.15 weight % of a slip agent. For example, first layer 110 may include from 98.85 weight % to 99.75 weight % of the first polymer and from 0.25 weight % to 1.15 weight % of the slip agent.

The slip agent may include at least one of a primary amide slip agent, a secondary amide slip agent and a bis-amide slip agent. For example, the slip agent may include stearamides, oleamides, and erucamides. Examples of slip agents that may be useful include Acrawax® C (N,N′ ethylene bis-stearamide wax), paraffin wax, microcrystalline wax, montan wax, carnauba wax, polystyrene wax, polyethylene wax, polypropylene wax, beeswax, and anhydrous lanolin. The slip agent may be added to first layer 110 by using a masterbatch having a carrier polymer that is the same as or similar to the first polymer. The slip agent is blended with the first polymer.

First layer 110 further includes a first major surface 111 and a second major surface 112 opposite to first major surface 111. First layer 110 further includes a thickness 110T. Thickness 110T may be defined between first major surface 111 and second major surface 112. In some embodiments, thickness 110T may be in a range of from 12 microns (i.e., about 0.5 mil) to 254 microns (i.e., about 10 mil). In some embodiments, thickness 110T may be from 50 microns (i.e., about 2 mil) to 203 microns (i.e., about 8 mil).

First layer 110 forms a first exterior surface 101 of low COF packaging film 100. First major surface 111 of first layer 110 may correspond to first exterior surface 101 of low COF packaging film 100. First exterior surface 101 includes a surface area roughness (Sa) in a range of from 25 nanometers (nm) (i.e., about 1 microinch) to 250 nm (i.e., about 10 microinches).

As discussed above, first layer 110 forms first exterior surface 101. Low COF packaging film 100 may be produced with first exterior surface 101 having the surface area roughness (Sa) by providing surface features to first layer 110 in its melt state. For example, the first polymer (and other additives) of first layer 110, in the melt state, may be passed between a roller system including a nip roller and a counter roller. The nip roller may include a surface having a roughness (i.e., a surface roughness (Ra)) that corresponds to a desired surface area roughness (Sa) of first exterior surface 101.

The roughened surface of the nip roller may provide the surface features to first layer 110 in the melt state as it passes through the roller system. The surface features provided to first layer 110 in such a manner may tend to be elongated in the machine direction.

First exterior surface 101 may have a static COF to itself less than 0.40 and a kinetic COF to itself less than 0.40, according to ASTM D1894. That is, first exterior surface 101 may have a low COF (specifically, a low static COF as well as a low kinetic COF) to itself.

The surface area roughness (Sa) of first exterior surface 101 in the range of from 25 nm to 250 nm may play a role in providing first exterior surface 101 with the low COF to itself. Further, first layer 110 including the slip agent may play a role in providing the first exterior surface with the low COF to itself. In some embodiments, a combination of first layer 110 including the slip agent and the surface area roughness (Sa) of first exterior surface 101 in the range of from 25 nm to 250 nm may provide first exterior surface 101 with the low COF to itself. The low COF of first exterior surface 101 may enhance packaging machine operations on low COF packaging film 100 and/or improve a line speed in production of packages formed from low COF packaging film 100.

Advantageously, first exterior surface 101 of low COF packaging film 100 may have the low COF without use of a slip coating. As a result, low COF packaging film 100 may be free from drawbacks that are associated with use of slip coatings. For example, use of slip coatings may necessitate periodic cleaning of packaging machines/equipment, that if neglected, may cause various quality defects in package production. Moreover, use of slip coatings may cause a reduction in recyclability. Low COF packaging film 100 may be free from such drawbacks.

Low COF packaging film 100 being free of slip coatings may increase a recyclability of low COF packaging film 100, reduce clean up times of packaging equipment, reduce quality issues in package production.

Furthermore, the surface area roughness (Sa) of first exterior surface 101 in the range of from 25 nm to 250 nm may not detrimentally affect optical properties of low COF packaging film 100 that are desirable in packaging applications (such as clarity and haze). In some embodiments, low COF packaging film 100 may include a haze in a range of from 1% to 50%, according to ASTM D1003, Procedure A. In some embodiments, low COF packaging film 100 may further include a clarity greater than 75%, according to ASTM D1003, Procedure A. In some embodiments, low COF packaging film 100 may further include a 60° gloss greater than 60%, according to ASTM D2457.

As a result, low COF packaging film 100 may include desirable optical properties and thus may be suitable for use in various packaging applications. It may be noted that a surface area roughness (Sa) of first exterior surface 101 greater than 250 nm may be detrimental to the desired optical properties of low COF packaging film 100.

FIG. 2 shows a schematic cross-sectional view of a low COF packaging film 200 in accordance with another embodiment of the present disclosure. Low COF packaging film 200 is similar to low COF packaging film 100 of FIG. 1, with like elements designated by like reference characters.

Low COF packaging film 200 includes first layer 110. Low COF packaging film 200 further includes a second layer 120. First layer 110 may be connected to second layer 120. Any suitable method may be employed to connect first layer 110 to second layer 120. For example, first layer 110 may be connected to second layer 120 by extrusion, coating, lamination, and the like.

Second layer 120 includes a first major surface 121 and a second major surface 122 opposite to first major surface 121. Second layer 120 further includes a thickness 120T. Thickness 120T may be defined between first major surface 121 and second major surface 122 of second layer 120. In some embodiments, thickness 120T may be in a range of from 5 microns (i.e., about 0.2 mil) to 25.4 microns (i.e., about 1 mil).

Low COF packaging film 200 includes first exterior surface 101 and a second exterior surface 102 opposite to first exterior surface 101. First layer 110 forms first exterior surface 101 of low COF packaging film 200. Further, second layer 120 forms second exterior surface 102 of low COF packaging film 200. First major surface 111 of first layer 110 may correspond to first exterior surface 101 of low COF packaging film 200. Second major surface 122 of second layer 120 may correspond to second exterior surface 102 of low COF packaging film 200.

Second layer 120 may be a sealing layer, or more specifically, a heat-sealing layer. Second layer 120 may be heat sealable to itself, and in some cases, may be heat sealable to a layer of another packaging film. In some embodiments, second layer 120 may include a heat sealable polymer blend. The heat sealable polymer blend may include a polyolefin polymer. That is, the heat sealable polymer blend may include polyethylene polymers and/or polypropylene polymers.

While not illustrated in FIG. 2, low COF packaging film 200 may optionally further include one or more intermediate layers positioned between first layer 110 and second layer 120. The one or more intermediate layers may impart desired additional functional characteristics, such as barrier properties, additional bulk, and the like, to low COF packaging film 200, and may be selected based on application requirements.

Low COF packaging film 200 may include a haze in a range of from 1% to 50%, according to ASTM D1003, Procedure A. Low COF packaging film 200 may further include a clarity greater than 75%, according to ASTM D1003, Procedure A. Low COF packaging film 200 may include a 60° gloss greater than 60%, according to ASTM D2457. Therefore, low COF packaging film 200 may be suitable for use in various packaging applications.

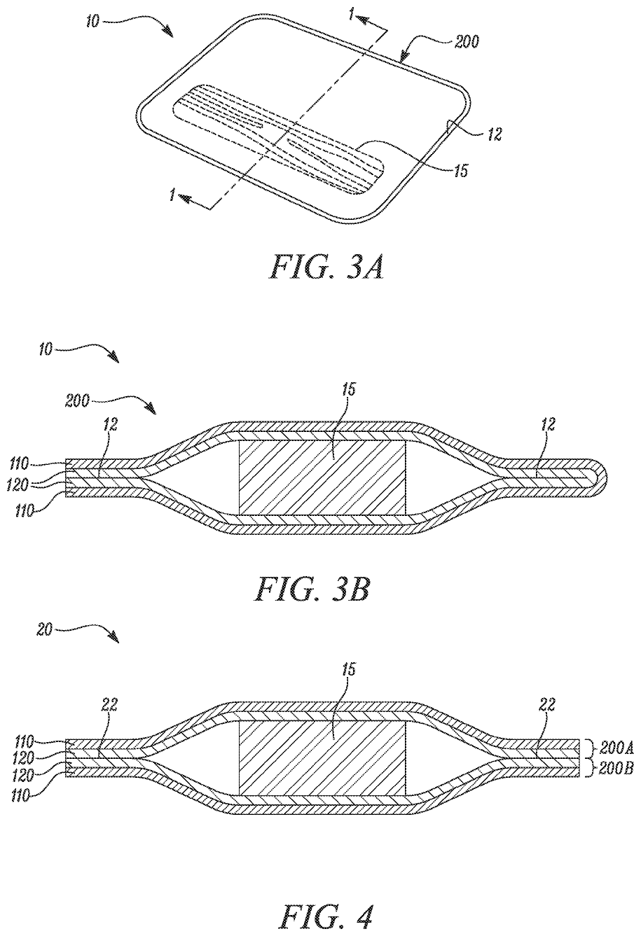

FIG. 3A shows a schematic perspective view of a package 10 in accordance with an embodiment of the present disclosure. FIG. 3B shows a schematic cross-sectional view of package 10 taken along a line 1-1 of FIG. 3A in accordance with an embodiment of the present disclosure.

Package 10 includes low COF packaging film 200 of FIG. 2. A product 15 may be packaged inside package 10. Product 15 may include a solid or a semi-solid item. Product 15 may be a food item. For example, product 15 may be a fresh meat product. Alternatively, product 15 may be a non-food item.

In the illustrated embodiment of FIG. 3B, low COF packaging film 200 is folded onto itself. Further, second layer 120 is sealed to itself. Specifically, package may include one or more heat seals 12 that seal second layer 120 to itself. As 10 shown in FIG. 3B, second layer 120 may face product 15. In other words, second layer 120 may be a product-facing layer. Moreover, in the illustrated embodiment of FIG. 3B, low COF packaging film 200 has been thermoformed into a non-planar shape. Low COF packaging film 200 may be thermoformed into any suitable non-planar shape based on application requirements.

FIG. 4 shows a schematic cross-sectional view of a package 20 in accordance with another embodiment of the present disclosure.

Package 20 includes a first low COF packaging film 200A and a second low COF packaging film 200B. Each of first low COF packaging film 200A and second low COF packaging film 200B is substantially similar to low COF packaging film 200 of FIG. 2, with like elements designated by like reference characters.

Specifically, each of first and second low COF packaging films 200A, 200B includes first layer 110 and second layer 120. Second layer 120 of first low COF packaging film 200A may be sealed to second layer 120 of second low COF packaging film 200B. Specifically, package 20 may include one or more heat seals 22 that seal second layer 120 of first low COF packaging film 200A to second layer 120 of second low COF packaging film 200B.

Each of first and second low COF packaging films 200A, 200B may be thermoformed to a desired non-planar shape prior to sealing of second layer 120 of first low COF packaging film 200A to second layer 120 of second low COF packaging film 200B.

### Experimental Results

Ten packaging films were produced for experimental purposes, noted here as Film 1 through Film 10. Each of the packaging films had a general structure of [1 mil PA-6 (nylon 6) blend layer/2 mil ionomer sealing film]. Of these packaging film examples, Film 6 was an example of the claimed invention and Films 1-5 and 7-10 were comparative examples.

The packaging films were produced by an extrusion coating process wherein the PA-6 blend was extrusion coated onto the ionomer sealing film. The process included a nip roller, having contact with the PA-6 blend layer, and a counter roller, having contact with the ionomer sealing film.

Various nip rollers were used to produce the packaging films. For some packaging films, the nip roller used had a mirror surface finish (i.e., a smooth surface finish). For some other packaging films, the nip roller used had a rough surface finish (i.e., a rough surface having a non-zero Ra value).

The nip rollers having the rough surface finish provided the PA-6 blend layer with corresponding rough surface features during production. Consequently, the PA-6 blend layer of the packaging films produced using the nip rollers having the rough surface finish had a surface roughness corresponding to the surface finish of the respective nip rollers. Due to the method of production, the surface features of the film surface tended to be elongated in the machine direction. The surface finish of the nip rollers is listed in Table 1 provided below, given in arithmetic average surface roughness (Ra) as measured by a two-dimensional roughness profile using units of microinches.

In general, the PA-6 blend included PA-6 (such as Ultramid® B36 available from BASF or AEGIS H135ZP available from Advansix). The PA-6 blend of some packaging films further included a slip agent (specifically, Acrawax C available from Arxada) in the amount (in weight % of PA-6 blend layer) listed in Tables 1 and 2 provided below. Acrawax C is an N,N′ ethylene bis-stearamide-based synthetic wax.

The ionomer sealing film was a two-layer film having a structure of (1.55 mil ULDPE-LDPE blend/0.45 mil ionomer). The PA-6 blend was extrusion coated onto the ULDPE-LDPE side of the ionomer sealing film, and the ionomer layer functioned as a sealing layer at the surface of the ionomer sealing film.

In one packaging film (Film 1), a slip coating was further applied on the surface of the PA-6 blend layer. The slip coating was applied at a coating weight of 1 pound/ream (lb/rm).

Unless specified in Tables 1 and 2, the PA-6 blend of the packaging film did not include the slip agent (Acrawax C). Unless specified in Tables 1 and 2, the packaging film did not include the slip coating applied to the PA-6 blend layer. In Table 1, “Roller Surface Finish” specifies the surface finish of the nip roller used for production of the packaging film and specifies the surface roughness (Ra) value (in microinches) of the surface of the nip roller.

Out/Out coefficient of friction refers to the coefficient of friction of the exterior surface of the PA-6 blend layer to itself measured according to ASTM D1894. Out/Metal coefficient of friction refers to the coefficient of friction of the exterior surface of the PA-6 blend layer to the metal described in and measured according to ASTM D1894.

TABLE 1
COF properties of packaging films

| | Roller Surface | Coefficient of Friction (COF) | | | |
|---|---|---|---|---|---|
| | Finish | Out/Out | | Out/Metal | |
| Packaging Film | (microinches) | Static | Kinetic | Static | Kinetic |
| Film 1 (slip coating) | Mirror | 0.31 | 0.24 | 0.18 | 0.15 |
| | (smooth) | | | | |
| Film 2 | Mirror | Too tacky to | | 0.2 | 0.15 |
| | (smooth) | test | | | |
| Film 3 (0.5% Acrawax C) | Mirror | Too tacky to | | 0.21 | 0.18 |
| | (smooth) | test | | | |
| Film 4 (1% Acrawax C) | Mirror | Too tacky to | | 0.45 | 0.34 |
| | (smooth) | test | | | |
| Film 5 (1.15% Acrawax C) | Mirror | Too tacky to | | 0.39 | 0.38 |
| | (smooth) | test | | | |
| Film 6 (0.5% Acrawax C) | 4-6 Ra | 0.22 | 0.18 | 0.13 | 0.13 |
| Film 7 (0.5% Acrawax C) | 20 Ra | 0.23 | 0.17 | 0.14 | 0.14 |
| Film 8 (1% Acrawax C) | 30-40 Ra | 0.25 | 0.24 | 0.22 | 0.18 |
| Film 9 (0.5% Acrawax C) | 40 Ra | 0.21 | 0.19 | 0.14 | 0.13 |
| Film 10 (0.5% Acrawax C) | 60 Ra | 0.26 | 0.19 | 0.14 | 0.13 |

Optical properties of each of the packaging films were further tested. Clarity of each of the packaging films was determined in accordance with ASTM D1003-13. Haze of each of the packaging films was determined in accordance with ASTM D1003-13. 60° gloss of each of the packaging films was determined in accordance with ASTM D2457-13. The determined clarity, haze, and 60° gloss values are listed in Table 2 provided below.

TABLE 2
Optical properties of packaging films

| | Clarity | Haze | 60° gloss |
|---|---|---|---|
| Packaging Film | (%) | (%) | (units) |
| Film 1 (slip coating) | 80.3 | 13.8 | 101 |
| Film 6 (0.5% Acrawax C) | 85 | 18.7 | 66.6 |
| Film 7 (0.5% Acrawax C) | 34.9 | 72.5 | 62.1 |
| Film 9 (0.5% Acrawax C) | 27 | 73.6 | 63.8 |
| Film 10 (0.5% Acrawax C) | 51.4 | 56.4 | 66.4 |

Film 1 was a comparative packaging film that included the slip coating applied to the PA-6 blend layer. Film 2 was similar to Film 1 without the slip coating. Films 3-5 included the slip agent in the PA-6 blend and were produced using the extrusion roller having the mirror surface finish, with increasing amounts of slip agent.

Film 6 was an inventive packaging film in accordance with the present disclosure. As illustrated by Table 1, for Film 6, the static COF of the exterior surface to itself was 0.22 and the kinetic COF of the exterior surface to itself was 0.18. As illustrated by Table 2, Packaging Film 6 had a clarity of 85%, a haze of 18.7%, and a 60° gloss of 66.6.

The surface features of Film 6 (i.e., the inventive packaging film) were characterized using a confocal Raman spectroscopy microscope and a scanning electron microscope (SEM). A laser spot measurement on the confocal Raman spectroscopy microscope indicated that the depth of the surface features was an average of 0.4 microns. A cross-sectional measurement on the SEM found many of the features had a depth of less than 0.25 microns. The width of the surface features ranged from 1.5 microns to about 8 microns, and the length of the surface features ranged from 2 microns to about 40 microns.

As compared to the comparative packaging film (Film 1), the inventive packaging film (Film 6) had a slightly lower coefficient of friction without the use of the slip coating. Moreover, the inventive packaging film (Film 6) had good optical properties (specifically, clarity, haze, and gloss).

Films 7-10 were produced with nip rollers having surfaces with incrementally increasing surface roughness (Ra) values. As illustrated by Table 2, use of the nip rollers having higher surface roughness (Ra) (ranging from to 20 Ra to 60 Ra) to produce Films 7-10 did not result in a further reduction in the coefficient of friction of Films 7-10 in a significant manner when compared to the inventive packaging film (Film 6). Moreover, use of the nip rollers having the higher surface roughness (Ra) (ranging from to 20 Ra to 60 Ra) to produce Films 7-10 resulted in Films 7-10 having worse visual characteristics (specifically, clarity, haze, and gloss) when compared to the inventive packaging film (Film 6).

It was concluded that a packaging film including an exterior surface formed by a polymeric layer with a slip agent in a range of from 0.25% to 1.15%, by weight and having a surface area roughness (Sa) in a range of from 25 nm to 250 nm has good optical properties suitable for packaging applications. Moreover, the exterior surface of such packaging film has a low coefficient of friction to itself.

1. A low coefficient of friction (COF) packaging film comprising:
a first layer forming a first exterior surface of the low COF packaging film, the first layer comprising a first polymer; and
a second layer forming a second exterior surface of the low COF packaging film, the second layer comprising a heat sealable polymer blend;
wherein:
the first layer is connected to the second layer;
the first exterior surface comprises a surface area roughness (Sa) in a range of from 25 nanometers (nm) to 250 nm, according to ISO 25178; and
the first exterior surface has a static COF to itself less than 0.40 and a kinetic COF to itself less than 0.40, according to ASTM D1894.

2. The low COF packaging film according to claim 1, wherein the first layer further comprises a slip agent blended into the first polymer.

3. The low COF packaging film according to claim 2, wherein the slip agent is comprised in a range of from 0.25% to 1.15% of a slip agent, by weight.

4. The low COF packaging film according to claim 2, wherein the slip agent comprises at least one of a primary amide slip agent, a secondary amide slip agent and a bis-amide slip agent.

5. The low COF packaging film according to claim 1, wherein the first layer comprises a thickness in a range of from 12 microns to 254 microns.

6. The low COF packaging film according to claim 1, wherein the first polymer is one of a polymer selected from the list of a polyamide polymer, a styrene polymer, a polyester polymer, and a polypropylene polymer.

7. The low COF packaging film according to claim 1, wherein the first polymer is a polycaprolactam polymer.

8. The low COF packaging film according to claim 1, wherein the heat sealable polymer blend comprises a polyolefin polymer.

9. The low COF packaging film according to claim 1, comprising a haze in a range of from 1% to 50%, according to ASTM D1003, Procedure A.

10. The low COF packaging film according to claim 1, comprising a clarity greater than 75%, according to ASTM D1003, Procedure A.

11. A low coefficient of friction (COF) packaging film comprising:
a first layer forming a first exterior surface of the low COF packaging film, the first layer comprising a polyamide polymer and in a range of from 0.25 weight % to 1.15 weight % of a slip agent;
wherein:
the first exterior surface comprises a surface area roughness (Sa) in a range of from 25 nm to 250 nm, according to ISO 25178; and
the low COF packaging film comprises a haze in a range of from 1% to 50% and a clarity greater than 75%, according to ASTM D1003, Procedure A.

12. The low COF packaging film according to claim 11, wherein the first exterior surface has a static COF to itself less than 0.40 and a kinetic COF to itself less than 0.40, according to ASTM D1894.

13. The low COF packaging film according to claim 11, wherein the first layer comprises a thickness in a range of from 12 microns to 254 microns.

14. The low COF packaging film according to claim 11, wherein the first polymer is a polycaprolactam polymer.

15. The low COF packaging film according to claim 11, wherein the slip agent comprises at least one of a primary amide slip agent, a secondary amide slip agent and a bis-amide slip agent.

16. A package comprising a low coefficient of friction (COF) packaging film, the low COF packaging film comprising:
a first layer forming a first exterior surface of the low COF packaging film, the first layer comprising a first polymer; and
a second layer forming a second exterior surface of the low COF packaging film, the second layer comprising a heat sealable polymer blend;
wherein:
the first layer is connected to the second layer;
the first exterior surface comprises a surface area roughness (Sa) in a range of from 25 nm to 250 nm, according to ISO 25178; and
the first exterior surface has a static COF to itself less than 0.40 and a kinetic COF to itself less than 0.40, according to ASTM D1894.

17. The package according to claim 16, wherein the low COF packaging film has been thermoformed into a non-planar shape.

18. The package according to claim 16, wherein the low COF packaging film is folded onto itself, and wherein the second layer is sealed to itself.

19. (canceled)
